(19) United States
(12) Patent Application Publication
(10) Pub. No.: US 2005/0117062 A1
(43) Pub. Date: Jun. 2, 2005

(54) Device for automatic display adjustment

(76) Inventors: Tsan-Nan Chien, Taipei City (TW); Yen-Chun Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/892,868

(22) Filed: Jul. 16, 2004

(30) Foreign Application Priority Data
Dec. 2, 2003 (TW) 92133818

(51) Int. Cl. H04N 5/58

(52) U.S. Cl. 348/602; 345/207

(57) ABSTRACT

A display device with automatic display adjustment. One or multiple brightness sensors in a display device detect environmental brightness signals and generate a brightness signal value, transmitted to a display control circuit of the display device. The display control circuit records, compares, and evaluates the brightness signal value and adjusts the display settings of the display device accordingly.

### BACKGROUND

The present invention relates to a display device, and in particular to a device for automatic brightness and light contrast adjustment of a display.

Conventional display devices provide brightness and light contrast adjustment in response to an environment around the display devices. For example, the brightness and contrast of display should be increased when environmental brightness intensifies, and decreased, when diminishes.

Display settings cannot be automatically adjusted by current display devices when environmental brightness is highly variable, and must be manually adjusted for better display, creating inconvenience.

FIG. 1 is a schematic diagram showing the architecture of a conventional display device.

The display device 100 receiving an image signal 110 comprises a control key 120, a display control circuit 130, a memory 140, and a display module 150.

FIG. 2 is a flowchart of display setting adjustment in a conventional display device.

In step S21, image signal 110 is retrieved from a video source and input to display device 100.

In step S221, brightness and contrast of display device 100 are adjusted by control key 120 when image signal 110 is input.

In step S222, display settings are stored in memory 140 after brightness and contrast adjustment of display device 100 is complete.

In step S23, display control circuit 130 adjusts image signal 110 according to the display settings for an optimum display mode.

In step S24, the adjusted image is output to display module 150.

A display device can be applied to a TV set, personal computer, portable computer, mobile phone, or LED billboard, wherein the display quality is affected by environmental brightness. The described process, however, relies on inconvenient manual adjustment and may not provide accurate results.

### SUMMARY

Accordingly, an object of the present invention is to provide a display device for automatic display adjustment, adjusting display settings in accordance with environmental brightness.

According to the object described, an embodiment of the present invention provides a display device with automatic display adjustment. The device comprises at least one brightness sensor detecting environmental brightness, and a display control circuit processing brightness signals received from the brightness sensor and automatically adjusting display settings of a display device accordingly.

The display control circuit records, compares, and evaluates the brightness signals and adjusts the display settings of the display device accordingly. In addition, the device further comprises a storage medium storing display settings and received brightness signal values.

An embodiment of the present invention further provides a display device with automatic display adjustment. The device comprises at least one brightness sensor detecting environmental brightness to obtain an initial brightness signal value and continuing to detect environmental brightness to obtain a first brightness signal value, and a display control circuit comparing the initial brightness signal value with the first brightness signal value when environmental brightness changes, and automatically adjusting display settings of a display device accordingly.

In addition, the device further comprises a storage medium storing display settings and received brightness signal values.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram showing the architecture of a conventional display device;

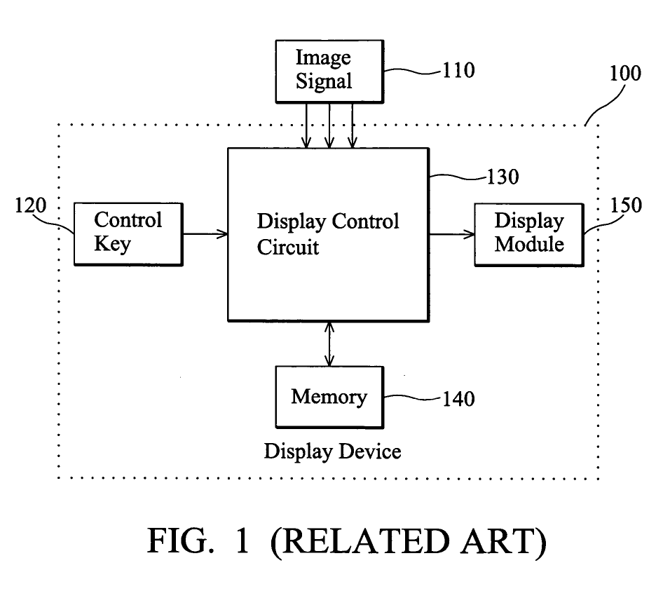

FIG. 2 is a flowchart of display setting adjustment in a conventional display device;

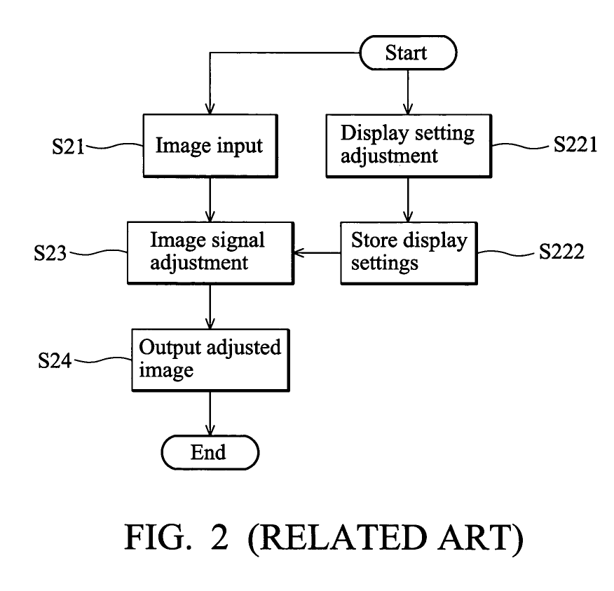

FIG. 3 is a schematic diagram showing the architecture of the display device of an embodiment of the invention;

FIG. 4 is a flowchart of display setting adjustment in an embodiment of the invention; and

FIG. 5 is a flowchart of display setting adjustment in response to environmental brightness variations according to an embodiment of the invention.

### DETAILED DESCRIPTION

An embodiment of the present invention provides a display device with automatic display adjustment in response to environmental brightness variations.

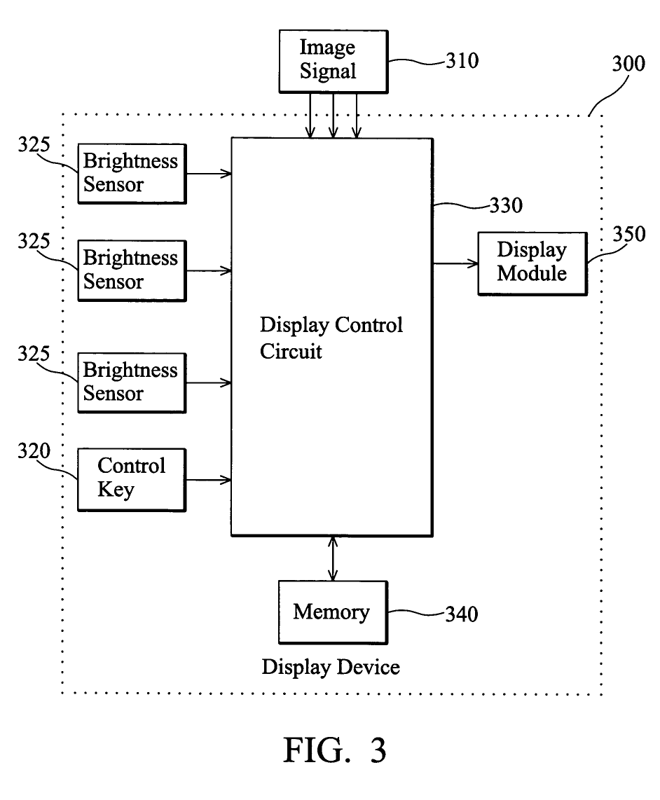

FIG. 3 is a schematic diagram showing the architecture of the display device of an embodiment of the invention. A display device 300 receiving an image signal 310 comprises a control key 320, brightness sensors 325, a display control circuit 330, a memory 340, and a display module 350.

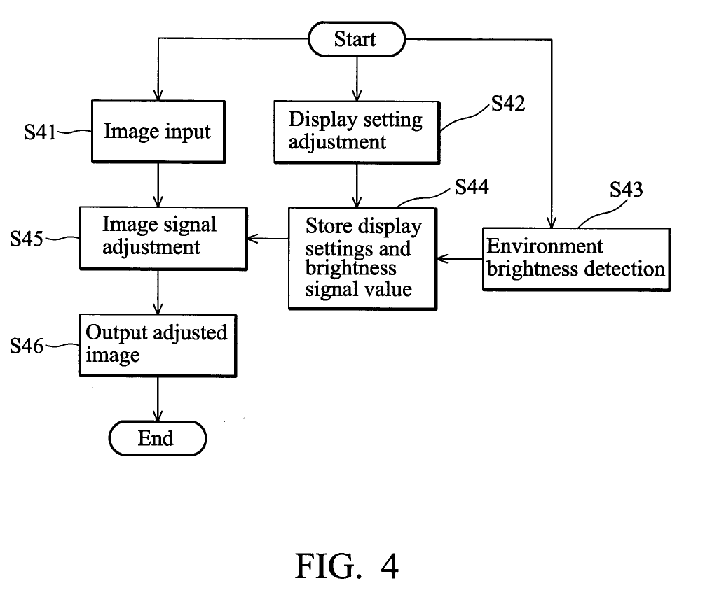

FIG. 4 is a flowchart of display setting adjustment in an embodiment of the invention.

In step S41, image signal 310 is retrieved from a video source and input to display device 300.

In step S42, brightness and contrast of display device 300 are adjusted, first according to environmental brightness, and then to user preference when the device is first used.

In step S43, brightness sensors 325 detects environmental brightness when display settings are first adjusted to obtain a default brightness signal value.

In step S44, the display settings and default brightness signal value are stored in memory 340 for comparison and adjustment.

In step S45, image signal 310 is adjusted according to the display settings for an optimum display mode.

In step S46, the adjusted image is output to display module 350.

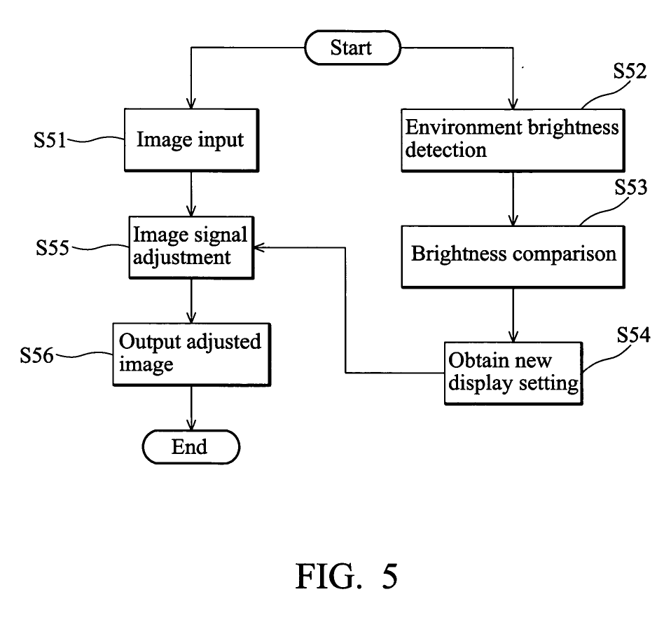

FIG. 5 is a flowchart of display setting adjustment in response to environmental brightness variations according to an embodiment of the invention.

In step S51, image signal 310 is retrieved from a video source and input to display device 300.

In step S52, environmental brightness is detected by brightness sensors 325.

In step S53, a new brightness signal value is obtained and compared with preset environmental brightness signal values in memory 340.

In step S54, a new display setting is obtained according to the comparison and the default display setting.

In step S55, image signal 310 is adjusted according to the new display setting for optimum display.

In step S56, the adjusted image is output to display module 350,

An embodiment of the present invention adjusts one or multiple brightness sensors in a display device to detect environmental brightness and transmits a generated brightness signal to a display control circuit of the display device. The display control circuit records, compares, and evaluates the brightness signal and adjusts the display settings of the display device accordingly.

While the invention has been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A display device with automatic display adjustment, comprising:
at least one brightness sensor, detecting environmental brightness and generating a brightness signal value; and
a display control circuit, coupled to the brightness sensor, processing the brightness signal value from the brightness sensor and automatically adjusting a default display setting of a display device accordingly.

2. The display device as claimed in claim 1, wherein the display control circuit records, compares, and evaluates the brightness signal value and adjusts the display settings of the display device accordingly.

3. The display device as claimed in claim 1 further comprising a storage medium, storing the default display setting and the brightness signal value.

4. The display device as claimed in claim 1, wherein the display device is a TV, monitor, LCD TV, plasma TV, projector, or LED billboard.

5. The display device as claimed in claim 1, wherein the brightness sensor is a circuit comprising a semiconductor element, an optical element, an integrated optical element, or a photoresistor.

6. The display device as claimed in claim 1, wherein the brightness signal is an optical signal, an analog signal, or a digital signal.

7. A display device with automatic display adjustment, comprising:
at least one brightness sensor, detecting environmental brightness to obtain an initial brightness signal value and continuing detecting the environmental brightness to obtain a first brightness signal value; and
a display control circuit, coupled to the brightness sensor, comparing the initial brightness signal value with the first brightness signal value when environmental brightness changes, and automatically adjusting display settings of a display device accordingly.

8. The display device as claimed in claim 7 further comprising a storage medium, storing the display settings and the brightness signal values.

9. The display device as claimed in claim 7, wherein the display device is a TV, monitor, LCD TV, plasma TV, projector, or LED billboard.

10. The display device as claimed in claim 7, wherein the brightness sensor is a circuit comprising a semiconductor element, an optical element, an integrated optical element, or a photoresistor.

11. The display device as claimed in claim 7, wherein the brightness signal is an optical signal, an analog signal, or a digital signal.
